(19) United States
(12) Patent Application Publication
(10) Pub. No.: US 2017/0363220 A1
(43) Pub. Date: Dec. 21, 2017

(54) MULTIWAY CONTROL VALVE HAVING A SEALING CARRIER

(71) Applicant: WOCO Industrietechnik GmbH, Bad Soden-Salmunster (DE)

(72) Inventors: Chunxiao YAN, Hanau (DE); Klemens SCHANDER, Baesweiler (DE)

(21) Appl. No.: 15/623,029

(22) Filed: Jun. 14, 2017

(30) Foreign Application Priority Data
Jun. 15, 2016 (DE) 202016103160.5

(51) Int. Cl. F16K 27/06; F16K 25/00; F16K 11/087; F16K 27/10; F16K 11/085

(52) U.S. Cl. CPC F16K 27/06; F16K 27/107; F16K 11/085; F16K 11/0876; F16K 25/005

(57) ABSTRACT

The present invention relates to a multiway valve for controlling at least one flow of at least one fluid, in particular within a motor vehicle, including at least one housing and one valve member disposed at least in areas within at least one valve space which is configured at least in areas within the housing, and by way of changing a rotary position of the valve member within the valve space about a first rotary axis, at least the amount of an inflow of the fluid from at least one first fluid connector into the valve space and/or at least the amount of outflow of the fluid out of the valve space is adjustable by at least one second fluid connector, and the multiway valve includes at least one insert which is disposed at least in areas between the valve member and the housing and is connected in a rotationally fixed manner to the housing.

### CROSS REFERENCE TO RELATED APPLICATION

This application claims priority to German Application No. 20 2016 103 160.5, filed on Jun. 15, 2016. This application, in its entirety, is incorporated herein by reference.

### FIELD OF THE DISCLOSURE

The present invention relates to a multiway valve for controlling at least one flow of at least one fluid, in particular within a motor vehicle, including at least one housing and one valve member disposed at least in areas within at least one valve space which is configured at least in areas within the housing, and by way of changing a rotary position of the valve member within the valve space about a first rotary axis, at least the amount of an inflow of the fluid from at least one first fluid connector into the valve space and/or at least the amount of outflow of the fluid out of the valve space is adjustable by at least one second fluid connector, and the multiway valve includes at least one insert which is disposed at least in areas between the valve member and the housing and is connected in a rotationally fixed manner to the housing.

### BACKGROUND

Such multiway valves are known from the prior art in different ways. For example, DE 10 2006 032 584 A1 discloses a roller sluice gate arrangement. This roller sluice gate arrangement is used in an internal combustion engine to control the flow of a cooling or heating fluid in a line system. It is provided that an exemplary roller sluice gate with clearance and disposed in a rotatable manner is situated in a housing, having a cavity at the flange of the roller sluice gate, which is covered by an elastic sealing element.

Disadvantageous for this multiway valve is, however, that on account of the friction between the sealing element of the roller sluice gate and the housing, an increased abrasion of the sealing element results so that a premature failure of the roller sluice gate occurs.

Furthermore, EP 3 009 719 A1 discloses a multiway valve for controlling liquid cycles. Also for this multiway valve it is provided that a valve unit in the form of a rotary piston is disposed within a valve housing. The rotary piston includes at least one through-flow opening and, in areas outside of this through-flow opening, sealing arrangements are fixed to the outer wall surface of the rotary piston.

This multiway valve has however also the disadvantage that, on account of the frictional forces between the sealing arrangement and the valve housing, an increased abrasion results when the rotary piston is rotated. Thus, on account of a leakage by damage to the sealing arrangement, a premature failure impends also for this multiway valve.

Finally, WO 87/00598 A1 discloses a generic multiway valve. It is provided that an insert is inserted into a cylindrical pipe of a main pipe, from which further supply lines branch out. This insert is attached in the pipe with the aid of screwing or welding. Then, a rotatable element is inserted into the insert, on the surface of which a seal is disposed. This multiway valve also has the disadvantages described previously.

Moreover, special arrangements have to be made for the aforementioned multiway valves to achieve, even for rotations and concomitant forces of gravity, a secure fastening of the seals to the respective valve member, as a result of which a complex production and installation process results. The fastening devices of the seals also result in an increased demand for installation space so that the multiway valves occupy a comparatively large installation space.

It is therefore the object of the present invention to further develop the generic multiway valve in such a manner that the disadvantages of the prior art are overcome; in particular, that a compact design of the multiway valve is achieved, that the production of the multiway valve is simplified and that a greater safeguarding against failure is achieved.

### SUMMARY

According to the present invention, this object is achieved in that the insert has at least one sealing arrangement.

Furthermore, the present invention provides that the fluid includes at least one heating fluid and/or cooling fluid and/or that the fluid includes at least one liquid, at least one gas and/or at least one gel.

The present invention also provides that the first fluid connector and/or the second fluid connector is/are at least in areas enclosed by the housing.

Preferred embodiments of the present invention provide that at least two, in particular a plurality of first fluid connectors and/or second fluid connectors are provided, preferably that the first fluid connector includes at least one main inlet and/or that at least one second fluid connector includes at least one main outlet and that at least one further second fluid connector includes a bypass outlet, in particular that the main inlet is connectable, in particular is connected, to at least one heating and/or cooling circuit of the motor vehicle and/or that the main outlet is connectable, in particular connected, to at least one radiator of the motor vehicle and/or that the bypass outlet is connectable, in particular is connected, to at least one bypass line in particular bypassing the radiator.

A multiway valve according to the present invention may also be characterized by the fact that the valve member includes at least one rotary piston, at least one rotary ball, at least one rotary piston segment and/or at least one rotary ball segment.

The present invention furthermore provides that, in at least a first position of the valve member, a connection between a first first fluid connector, in particular the main inlet, and a first second fluid connector, in particular the main outlet, is open, and, in at least a second position of the valve member, a connection between a second first fluid connector, in particular the main inlet, and a second second fluid connector, in particular the bypass outlet, is open.

In the aforementioned embodiment, it is particularly preferred that the first first fluid connector and the second first fluid connector are identical or that the first second fluid connector and the second second fluid connector are identical, that, in the first position of the valve member, the connection between the second first fluid connector and the second second fluid connector is closed and/or that, in the second position of the valve member, the connection between the first first fluid connector and the first second fluid connector is or are closed.

Furthermore, it is provided for the two aforementioned embodiments that in at least a third position, preferably a position between the first position and the second position, a connection between the first first fluid connector on the one hand and the first second fluid connector and/or the second second fluid connector on the other hand, and/or that a connection between the second first fluid connector on the one hand and the first second fluid connector and/or the second second fluid connector on the other hand is or are at least partially open.

It is particularly preferable that at least one first fluid connector and/or at least one second fluid connector is situated in the housing in such a manner that the fluid in relation to the first rotary axis flows in the radial direction into the valve space or out of the valve space and/or that at least one first fluid connector and/or one second fluid connector is/are situated in the housing in such a manner that the fluid in relation to the first rotary axis flows in the axial direction into the valve space or out of the valve space.

In the aforementioned embodiment, it is particularly preferable that the fluid flows through the main inlet in a radial direction into the valve space, flows through the main outlet in an axial direction out of the valve space and/or flows through the bypass outlet in a radial direction out of the valve space.

Furthermore, the multiway valve according to the present invention may be characterized by at least one fixing device, by means of which the insert is held at least in a rotary fixed manner, in particular is held non-positively and/or positively, at least about the first rotary axis relative to the housing, in particular including at least two fixing elements, for example tongue-and-groove elements, threaded elements and/or clip elements, which are configured in a complementary manner to each other, and preferably are, on the one hand, configured at least in areas at the insert and/or, on the other hand, at least in areas at the housing.

The present invention also provides that the sealing arrangement includes, at least on the side facing the valve member, at least in areas a material reducing a friction between the valve member and the insert, preferably polytetrafluorethylene (PTFE), polyvinylidenfluoride (PVDF) and/or perflouroalkoxy polymer (PFA), in particular in the form of at least one coating and/or in that the insert includes the material reducing the friction at least in areas, and preferably is made at least in areas from this material.

A particularly preferable embodiment provides that the sealing arrangement includes, in particular on the surface facing away from the valve member and/or facing the housing, at least one sealing element connected to the insert in a positive, non-positive and/or intermaterial manner, the sealing element in particular being connected to the insert at least in areas by way of injection molding, welding, vulcanizing, positioning in at least one recess and/or groove, adhesive bonding, clipping and/or spraying.

Furthermore, the present invention provides that the sealing arrangement, in particular the sealing element, includes at least one first first sealing area, which is situated in the area of at least one first fluid connector, preferably a first fluid connector enabling a radial flow of the fluid into the valve space in relation to the first rotary axis, in particular in the area of run-in of the first fluid connector into the valve space, preferably completely surrounding the area of run-in, and/or that at least one second second sealing area, which is situated in the area of at least one second fluid connector, preferably a second fluid connector enabling a radial flow of the fluid out of the valve space in relation to the first rotary axis, in particular in the area of run-in of the second fluid connector into the valve space, preferably completely surrounding the area of run-in of the second fluid connector.

It is also preferred that the sealing element at least in areas includes at least one elastic material, for example ethylene propylene diene monomer rubber (EPDM), includes at least one lip seal and/or multiple-lip seal, and/or that the valve member on the surface facing the insert has at least one first contouring and/or that the carrier on the surface facing the valve member has at least in areas one second contouring, and/or the first contouring and/or the second contouring including at least one ridge, at least one edge and/or at least one bead.

A particularly preferable embodiment of the present invention may be characterized by the fact that, with the aid of the first contouring and/or the second contouring, in at least a fourth position of the valve member, a pressure, by means of which the sealing arrangement, in particular the sealing element, is urged at least in areas in the direction of the housing, is increased and/or the first contouring is in contact with the second contouring and/or the material reducing the friction.

Furthermore, the present invention provides that the fourth position corresponds to the first position and/or the second position, in particular that, in the first position, the first sealing area is prestressed against the inner wall of the valve space and/or is urged in the direction of the inner wall and/or, in the second position, the second sealing area is prestressed against the inner wall of the valve space and/or is urged in the direction of the inner wall.

Particularly preferable embodiments of the present invention provide that the first sealing area and the second sealing area have a substantially identical surface shape and/or circumference shape and are disposed in an off-set manner to each other along the circumference of the insert, that the second contouring includes at least one first second contouring area overlapping at least in areas with the first sealing area and at least one second second contouring area overlapping at least in areas with the second sealing area, and/or that the first sealing area, in the first position, overlaps the first contouring area at least in areas and/or that the second sealing area, in the second position, overlaps the first contouring area at least in areas, in particular, in the first position, being situated in the surface area of the carrier facing away from the first sealing area and/or abutting at the surface area of the carrier facing away from the first sealing area and/or, in the second position, being situated in the surface area of the carrier facing away from the second sealing area and/or abutting at the surface area of the carrier facing away from the second sealing area, preferably, that the first sealing area as well also the second sealing area have a surface shape, circumference shape and/or contour complementary to the first contouring.

It is also preferred that at least one cover, which closes the valve space at least in areas and/or which is at least releaseably connectable to the housing, in particular is attachable to the housing, [is provided].

The multiway valve according to the present invention may furthermore be characterized by at least one first, in particular fixedly specified, sealing member situated at least in areas between the housing and the cover, in particular including at least one quad ring, the first sealing member at least in areas being enclosed by the housing and/or the cover and/or being attached to the housing and/or the cover.

Finally, it is provided in the two aforementioned embodiments that the valve member at least in areas is mounted in at least one second sealing element, which is disposed at least in areas in the cover, in particular connected to the cover and/or at least in areas enclosed by the cover, preferably, that the second sealing member includes at least one radial shaft seal, in particular, a radial shaft seal ring.

Thus, the present invention is based on the surprising finding that by disposing an insert between a valve member and an inner wall of a housing or valve space, which has a sealing arrangement, a compact design of a multiway valve and, at the same time, a longer service life of the multiway valve can be ensured. In this way, a positioning of the sealing arrangement on the insert and simultaneous rotationally fixedly attaching the insert within the valve space results in that an excessive stress of the sealing arrangement is prevented by avoiding a relative rotary movement, which may result in undesirable forces of gravity at the sealing arrangement. In his way, in particular when positioning a sealing element of the sealing arrangement on the side facing away from the valve member, only a compression of an elastic part of the sealing arrangement results between the insert and the surface of the valve space, while a relative movement between the insert and the valve member only results on the side of the insert facing away from the sealing element, where optionally an incompressible part of the sealing arrangement, for example a PTFE coating, is disposed. In contrast, the sealing element with respect to the housing remains in relation to the rotary axis of the valve member stationary relative to the housing. Furthermore, a movement of the valve member relative to the inner wall of the insert is in particular facilitated in that the insert at least in areas includes a material having low frictional resistance, for example polytetrafluoroethylene (PTFE), which simultaneously provides a part of the function of the sealing arrangement. It is also conceivable that the side of the insert facing the valve member is coated by such a material.

The sealing element is disposed at the side of the carrier facing away from the valve member, in particular in a recess, and includes in particular an elastomer material, for example EPDM. The positing in a recess is however not mandatory. The sealing element may also be injected all around the side facing away from the valve member. If the sealing element shrinks after the injection, it is held by itself on the carrier. If the bonding between the sealing element and the carrier is not sufficient and the risk of rotation is presented, the surface of the carrier may be treated, for example by acid-treatment, so that the sealing element bonds well on the carrier.

On account of this construction of the valve, in particular on account that the insert is separately producible, the complete valve may be easily produced and installed, because the connection arrangement between the sealing element and the carrier can, owing to that the forces of gravity did not set in, be carried out in a comparably simple manner, a compact design of the insert as well as also of the sealing arrangement and of the complete valve result. The coating disposed on the side of the carrier facing the valve member reduces the friction between the valve member and the surrounding wall and, at the same time, also ensures the operative sealing, thus, the coating simultaneously partially fulfills the function of the sealing arrangement. Furthermore, a wearing of the sealing element is minimized to so achieve a longer service life. The sealing element offers a prestress and simultaneously a tolerance compensation, so that the gap between the carrier and the housing wall or the inner wall of the valve space is sealed and, in this way, the desired defined fluid flow paths may be achieved.

Moreover, the multiway valve according to the present invention offers a modular construction, which enables that different housings may be combined with different sealing arrangements, in particular sealing elements, and with different valve members. Thus, it is only necessary to keep one set of different inserts and valve members to implement different multiway valves, in particular having different functions, using one and the same housing. In so doing, a housing may have a plurality of fluid connectors and the insert enables that only a specific selection of these fluid connectors may be connected to one another by way of rotating the valve member.

The multiway valve may, in particular, be uses as a heat management module for controlling fluid circuits of vehicles, but also may be used in airplane construction and for sanitary applications, for example, in building heating systems. Preferably, the control valve has at least one inlet and at least one outlet. The valve member rotatably mounted in the valve space enables that the liquid flows or fluid flows are dispersed or disabled.

The use of the valve according to the present invention is however not limited to controlling a fluid circuit. Gases, gels or liquids in which solids are sublimated may also be controlled.

Preferably, the multiway valve or the housing has a plurality of fluid connectors for a fluid outflow or fluid inflow. Preferably, a main inlet of the multiway valve and a main outlet of the multiway valve are integrated into a fluid cycle. Additionally, the multiway valve may have a bypass outlet, as a result of which, by an adjustment of the valve member into a first position, 100% of the fluid is conducted from the main inlet to the main outlet and, at the same time, the bypass outlet is completely sealed. In a second position, 100% of the fluid may then be conducted from the main inlet to the bypass outlet and the main outlet is completely sealed vis-à-vis the main inlet and the bypass outlet.

In intermediate positions, a proportionate distribution between the main outlet and the bypass outlet may be furthermore achieved, thus, the multiway valve operates as a proportional valve.

In this instance, it is preferred that the main inlet enables in relation to the rotary axis of the valve member a radial supply of the fluid, while the fluid may outflow from the valve space via a main outlet axially disposed in relation to the first rotary axis. In this case, the bypass outlet may then enable a likewise radial outflow of the fluid from the valve space, making a sealing of the bypass outlet by the sealing element of the carrier possible.

Particularly preferably, the insert is rotationally fixedly connected to the housing by a positive connection. For example, the insert may have respective recesses and the housing may have respective projections engaging in one another and to so prevent a relative rotary movement about the first rotary axis.

A particularly simple manufacture of the insert and, hence, of the valve, results in that the sealing element is injected on the outer side of the insert. Elastomer materials, for example EPDM, have been proven to particularly suitable.

Preferably, the sealing arrangement, in particular the sealing element, has different sealing areas. The sealing areas are situated on the insert in such a manner and positioned relative to the housing that a fluid connector, which enables a radial inflow or outflow of the fluid to/from the valve space, is substantially completely surrounded by the respective sealing area. In particular, in combination with the valve member having a contouring, such as a sealing edge, it is made possible that, when the valve member is in a predetermined position, the respective sealing area is pressed against the inner wall of the valve space and, in this way, a sealing of the connector, in the area of which the sealing area is situated, is ensured. Thus, the sealing arrangement is disposed and configured at the carrier in such a manner that, in particular in the first position and the second position described before, the respective sealing area of the elastomer sealing arrangement overlaps with the contouring of the valve member. In this way, the sealing area is subjected to uniform prestressing and a best possible seal is achieved. If the valve member is then rotated from this position about the first axis, the relative position of the sealing area and of the contouring of the valve member is moved, so that the sealing area and the contouring of the valve member no longer completely overlap. In so doing, the prestress is reduced and, at the same time, also the friction between the valve member and the carrier is reduced, so that with the aid of the valve according to the present invention, a force made available by an actuator may also be reduced.

Preferably, the sealing areas of the sealing arrangement are at least in areas uniformly designed. This results in that, by modifying the position of the contouring of the valve member, a best possible prestressing may be achieved for the respective sealing area of the respective position of the valve member by the contouring of the valve member and the sealing arrangement in both positions overlapping to a maximum degree.

Preferably, the multiway valve according to the present invention has a cover, by which the valve space is closed. A sealing of the valve interior in relation to the cover may result in that at least one fixedly specified sealing member in the form of a quad ring and/or a radial shaft seal ring, which is/are disposed at the cover, is/are used. Alternatively, or additionally, it may be provided that no cover is provided between the housing and the cover. In this way, a permanent connection between the cover and the housing may be established. For this purpose, the cover includes, for example, a laser-transparent and a hydrolysis-stabilized material and is laser-welded to the housing, so that the sealing member may be omitted. With the aid of the radial shaft seal or the quad ring, it is particularly achieved that the valve member is guided in the best possible way and a gap between the cover and the valve member relatively rotatable to the cover is radially sealed.

### BRIEF DESCRIPTION OF THE DRAWINGS

Further features and advantages of the present invention result from the subsequent description, in which preferred embodiments of the present invention are described on the basis of schematic drawings.

FIG. 1 shows a perspective top view onto a multiway valve according to the present invention;

FIG. 2 shows an illustration of the multiway valve of FIG. 1, however, having a semi-transparently illustrated housing;

FIG. 3a shows a detailed view of the multiway valve according to cutout A of FIG. 2, however without a housing;

FIG. 3b shows a detailed view according to FIG. 3a of a further embodiment of the multiway valve according to the present invention;

FIG. 4a shows a view according to FIG. 3b by omitting the cover and, thus, of the semi-transparent illustration of the carrier in a first position of the valve member;

FIG. 4b shows a view according to FIG. 4a of the second embodiment of FIG. 3b;

FIG. 5a shows a view according to FIG. 4a, however in a second position of the valve member; and

FIG. 5b shows a view according to FIG. 5a of the second embodiment.

### DETAILED DESCRIPTION OF EMBODIMENTS

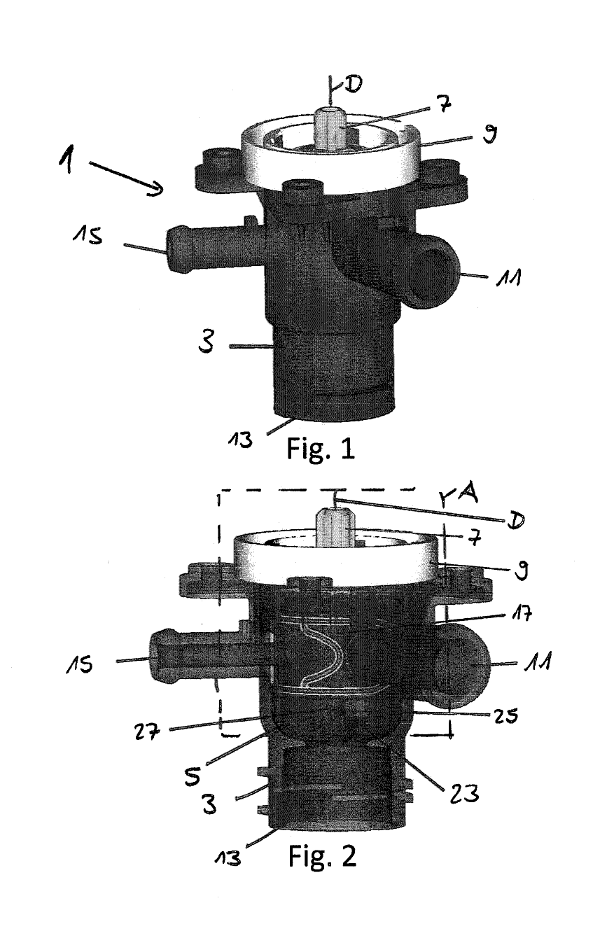

According to FIG. 1, a multiway valve 1 according to the present invention includes a housing 3. As can be seen from FIG. 2, a valve space 5 is configured within housing 3. In valve space 5, a valve member is disposed in the form of a rotary piston 7. Rotary piston 7 is rotatably mounted about a first rotary axis D and is moved via an actuator, which is not shown.

Housing 1 is closed with the aid of a cover 9, a part of rotary piston 7 protruding through cover 9.

In housing 3, a first fluid connector is configured in the form of a main inlet 11. Moreover, housing 3 has a first second fluid connector in the form of a main outlet 13 and a second second fluid connector in the form of a bypass outlet 15. By way of main inlet 11, a fluid may be supplied in the radial direction in relation to rotary axis D into valve space 5, while a fluid from valve space 5 outflows through main outlet 13 in an axial direction in relation to axis D and the fluid flows out of valve space 5 via bypass outlet 15 in a radial direction in relation to rotary axis D.

As may be concluded in particular from FIG. 2, an insert 17 is disposed within valve space 5. Insert 17 includes a material having a low frictional resistance, in particular polytetrafluorethylene (PTFE) and, preferably, insert 17 is made in areas from this material or has at least on the inner wall facing rotary piston 7 a coating having this material.

As it can be furthermore concluded from FIG. 2, a sealing element 19 is disposed as part of a sealing arrangement 18 on an outer surface of insert 17 facing the housing. The sealing element is formed by an EPDM lip seal inserted in a groove in insert 17. Sealing element 19 has a first sealing area 21a and a second sealing area 21b.

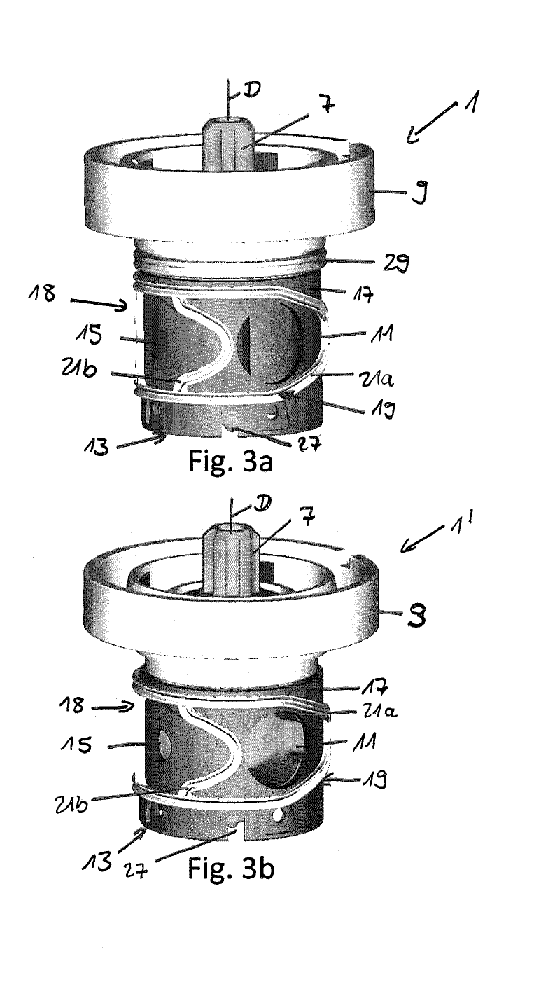

As can be seen in particular from FIGS. 3a through 5b, first sealing area 21a and second sealing area 21b are congruently formed; however, they are situated in different positions around the circumferential area of insert 17. As can be furthermore concluded from FIG. 2, insert 17 is rotatably fixedly mounted within housing 3 with the aid of a fixing device 23. In this instance, fixing device 23 has ridges 25, which are configured within housing 3, and thereto complementary recesses 27, which are configured in insert 17. When ridges 25 engage with recesses 27, a positive attachment of insert 17 in relation to rotary axis D is achieved.

FIG. 3a shows a view according to cutout A of FIG. 2 by omitting housing 3. As can be concluded from FIG. 3a, a first fixedly specified sealing member in the form of a quad ring 29 is disposed at cover 9. With the aid of quad ring 29, a sealing of housing 3 and of cover 9 results. Rotary piston 7 is held in cover 9 with the aid of a second sealing member, including at least one axial shaft sealing ring 29, indicated in FIG. 3a.

The second embodiment of a multiway valve 1′ illustrated in FIG. 3b differs from the first embodiment of FIG. 3a in that the cover and the housing are connected to each other by way of welding, so that the first sealing member in the form of quad ring 29 can be forgone.

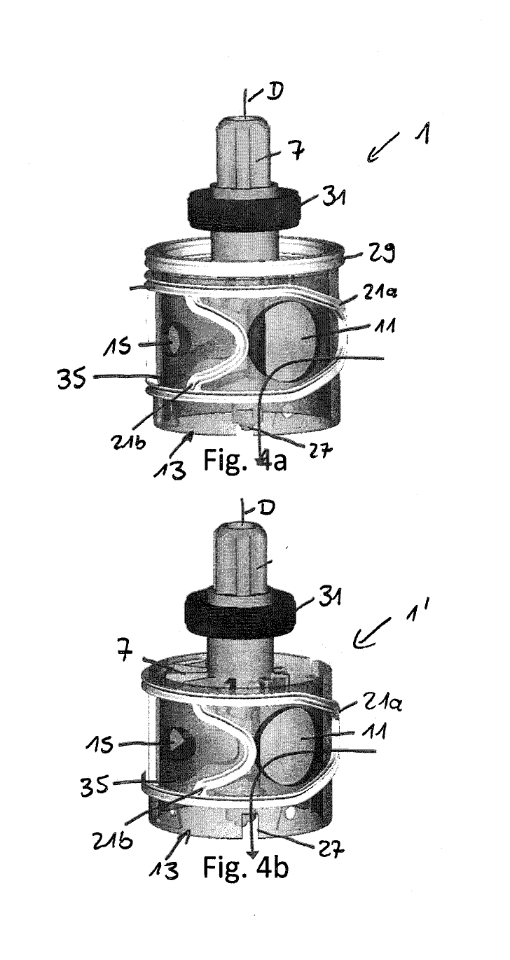

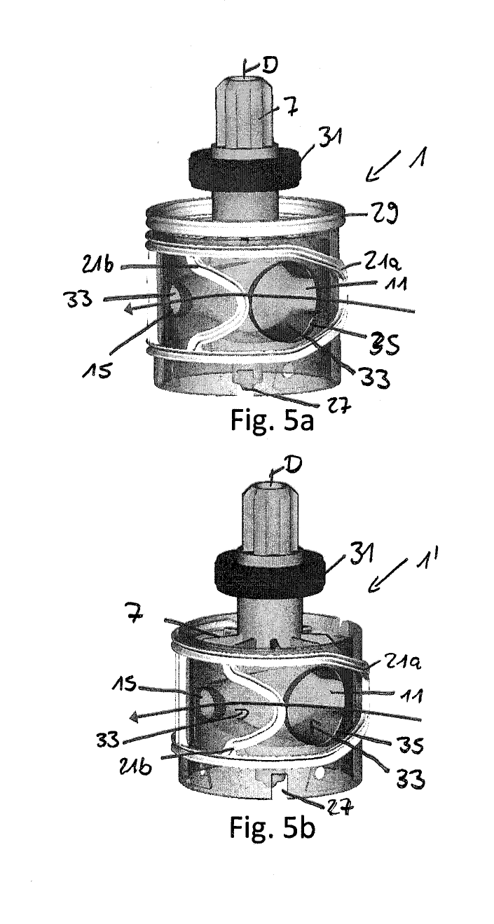

On the basis of FIGS. 4a through 5b, the mode of operation of multiway valve 1 is now described. In FIGS. 4a and 4b, rotary piston 7 is shown in a first position. In this position, a connection between main inlet 11 and main outlet 13 is open in that there is a fluidal connection between the main inlet and the main outlet. In contrast, a connection between main inlet 11 and a connection channel 33 configured in rotary piston 7 is closed, in particular connection channel 33 and bypass outlet 15 connected thereto in the first position are sealed vis-à-vis main inlet 11 and main outlet 13. Furthermore, rotary piston 7 has a first contouring in the form of a sealing edge 35. As can be concluded in particular from FIGS. 4a and 4b, sealing edge 35 in the first position is positioned opposite second sealing area 21b of sealing arrangement 18 or sealing element 19.

On account of this positioning, a pressing of sealing element 19, in particular of sealing area 21b, against the inner wall of valve space 5 results, in particular in the area in which bypass outlet 15 runs into valve space 5. In so doing, it is ensured that, with the aid of sealing area 21b, a sealing of the gap between insert 17 and housing 3 is achieved in such a manner that only a fluid flow between main inlet 11 and main outlet 13 is enabled and that this intermediate area between insert 17 and housing 3 is sealed with respect to the remaining area of valve space 5. Sealing edge 35 also ensures that a sealing in the area of the inner wall of insert 17 is achieved, so that no fluid is able to enter the intermediate space between rotary piston 7 and insert 17 in the area of bypass outlet 15 and of connection channel 33.

If rotary piston 7 is now transferred into the position shown in FIG. 5a or 5b, sealing edge 35 is in such a position that first sealing area 21a enters the area which is located between sealing edge 35 and the housing wall of valve space 5. In so doing, it is ensured that a best possible sealing of the opening communicating with bypass outlet 15 results in insert 17 vis-à-vis main outlet 13. This effects that a fluid supplied via main inlet 11 is exclusively guided via connection channel 33 to bypass outlet 15, while a fluid flow through main outlet 13 is completely inhibited. In this instance, the area between the housing wall and insert 17 is sealed by first sealing area 21a in the area of bypass outlet 15 as well as also in the area of main inlet 11, while a sealing of the area between insert 17 and rotary piston 7 is achieved on the inner side of insert 17 by the interplay of sealing edge 35 and the inner surface of insert 17. In so doing, a completely sealed fluid path, vis-à-vis the remaining areas of valve 1, is established from the main inlet via the opening in insert 17, through connection channel 33 and the further opening in the insert to bypass outlet 15.

If rotary piston 7 is located in an intermediate position between the first position shown in FIG. 4a or 4b and the second position shown in FIG. 5a or 5b, a partial fluid flow through main outlet 13 and bypass outlet 15 results depending on the overlap of connection channel 33 with the opening in insert 17 communicating with main inlet 11. In this instance, a leakage between the inner wall of valve space 5 and insert 17 occurs, because sealing edge 35 is also offset relative to first sealing area 21a as well as also to second sealing area 21b, so that sealing element 19 is no longer pressed to a maximum against the inner wall of inner space 5. This results in also reducing the prestress between insert 17 and sealing edge 35, so that even lower frictional forces occur and so that less torque is necessary to rotate rotary piston 7.

Alternative embodiments not shown may provide that on the surface of insert 17 facing away from respective sealing areas 21a, 21b, which faces rotary piston 7, an additional contouring, in particular ridges, is/are provided to further increase the difference in the contact pressure between the positions in which sealing edge 35 overlaps with the respective sealing areas and the positions in which this is not the case.

The features illustrated or described in the preceding description, the claims and the drawings may, individually as well as also in any combination, be substantial for the present invention in its various embodiments.

### LIST OF REFERENCE CHARACTERS

1, 1′ multiway valve

3 housing

5 valve space

7 rotary piston

9 cover

11 main inlet

13 main outlet

15 bypass outlet

17 insert

18 sealing arrangement

19 sealing element

21a sealing area

21b sealing area

23 fixing device

25 ridge

27 recess

29 quad ring

31 radial shaft seal ring

33 connection channel

35 sealing edge

A cutout

D rotary axis

1. The present invention relates to a multiway valve (1, 1′) for controlling at least one flow of at least one fluid, in particular within a motor vehicle, comprising at least one housing (3) and one valve member (7) disposed at least in areas within at least one valve space (5) which is configured at least in areas within the housing (3), wherein by way of changing a rotary position of the valve member (7) within the valve space (5) about a first rotary axis (D), at least the amount of inflow of the fluid from at least one first fluid connector (11) into the valve space (5) and/or at least the amount of outflow of the fluid out of the valve space (5) is adjustable by at least one second fluid connector (13, 15), wherein the multiway valve (1) comprises at least one insert (17) which is disposed at least in areas between the valve member (7) and the housing (3) and is connected in a rotationally fixed manner to the housing (3), characterized in that:
the insert (17) comprises at least one sealing arrangement (18).

2. The multiway valve as recited in claim 1, characterized in that:
the fluid comprises at least one heating fluid and/or cooling fluid and/or that the fluid comprises at least one liquid, at least one gas and/or at least one gel.

3. The multiway valve as recited in claim 1, characterized in that:
the first fluid connector (11) and/or the second fluid connector (13, 15) is/are at least in areas enclosed by the housing (3).

4. The multiway valve as recited in claim 1, characterized in that:
at least two, in particular a plurality of first fluid connectors (11) and/or second fluid connectors (13, 15) are provided, preferably that the first fluid connector comprises at least one main inlet (11), and/or that at least one second fluid connector comprises at least one main outlet (13) and that at least one further second fluid connector comprises a bypass outlet (15), in particular that the main inlet (11) is connectable, in particular is connected, to at least one heating and/or cooling circuit of the motor vehicle, and/or that the main outlet (13) is connectable, in particular connected, to at least one radiator of the motor vehicle and/or that the bypass outlet (15) is connectable, in particular is connected, to at least one bypass line, in particular bypassing the radiator.

5. The multiway valve as recited in claim 1, characterized in that:
the valve member comprises at least one rotary piston (7), at least one rotary ball, at least one rotary piston segment and/or at least one rotary ball segment.

6. The multiway valve as recited in claim 1, characterized in that:
in at least a first position of the valve member (7), a connection between a first first fluid connector, in particular the main inlet (11), and a first second fluid connector, in particular the main outlet (13), is open and that, in at least a second position of the valve member (7), a connection between a second first fluid connector, in particular the main inlet (11), and a second second fluid connector, in particular the bypass outlet (15), is open.

7. The multiway valve as recited in claim 6, characterized in that:
the first first fluid connector (11) and the second first fluid connector are identical or that the first second fluid connector and the second second fluid connector are identical, that, in the first position of the valve member (7), the connection between the second first fluid connector (11) and the second second fluid connector (15) is closed and/or that, in the second position of the valve member (7), the connection between the first first fluid connector (11) and the first second fluid connector (13) is or are closed.

8. The multiway valve as recited in claim 1, characterized in that:
in at least a third position, preferably a position between the first position and the second position, a connection between the first first fluid connector (11) on the one hand and the first second fluid connector (13) and/or the second second fluid connector (15) on the other hand, and/or that a connection between the second first fluid connector (11) on the one hand and the first second fluid connector (13) and/or the second second fluid connector (15) on the other hand is or are at least partially open.

9. The multiway valve as recited in claim 1, characterized in that:
at least one first fluid connector (11) and/or at least one second fluid connector (13) is situated in the housing (3) in such a manner that the fluid in relation to the first rotary axis (D) flows in the radial direction into the valve space (5) or out of the valve space (5) and/or at least one first fluid connector and/or at least one second fluid connector (13) is situated in the housing in such a manner that the fluid in relation to the first rotary axis (D) flows in the axial direction into the valve space (5) or out of the valve space (5).

10. The multiway valve as recited in claim 9, characterized in that:
the fluid flows through the main inlet (11) in a radial direction into the valve space (5), flows through the main outlet (13) in an axial direction out of the valve space (5) and/or flows through the bypass outlet (15) in a radial direction out of the valve space (5).

11. The multiway valve as recited in claim 1, characterized in that:
at least one fixing device (23), by means of which the insert (17) is held at least in a rotary fixed manner, in particular is held non-positively and/or positively, at least about the first rotary axis (D) relative to the housing (3), in particular comprising at least two fixing elements (25, 27), for example tongue-and-groove elements, threaded elements and/or clip elements, configured in a complementary manner to each other, and, on the one hand, preferably configured at least in areas at the insert (17) and/or, on the other hand, at least in areas at the housing (3).

12. The multiway valve as recited in claim 1, characterized in that:
the sealing arrangement (18) comprises, at least on the side facing the valve member (7), at least in areas a material reducing a friction between the valve member (7) and the insert (17), preferably polytetrafluorethylene (PTFE), polyvinylidenfluoride (PVDF) and/or perflouroalkoxy polymer (PFA), in particular in the form of at least one coating and/or in that the insert (17) comprises the material reducing the friction at least in areas, preferably is made at least in areas from this material.

13. The multiway valve as recited claim 1, characterized in that:
the sealing arrangement (18) comprises, in particular on the surface facing away from the valve member (7) and/or facing the housing (3), at least one sealing element (19) connected to the insert (17) in a positive, non-positive and/or intermaterial manner, wherein in particular the sealing element (19) is connected to the insert (17) at least in areas by way of injection molding, welding, vulcanizing, positioning in at least one recess and/or groove, adhesive bonding, clipping and/or spraying.

14. The multiway valve as recited in claim 1, characterized in that:
the sealing arrangement (18), in particular the sealing element (19), comprises at least one first first sealing area (21a), which is situated in the area of at least one first fluid connector (11), preferably a first fluid connector (11) enabling a radial flow of the fluid into the valve space (5) in relation to the first rotary axis (D), in particular in the area of run-in of the first fluid connector (11) into the valve space (5), preferably completely surrounding the area of run-in, and/or at least one second second sealing area (21b), which is situated in the area of at least one second fluid connector (15), preferably a second fluid connector enabling a radial flow of the fluid out of the valve space (5) in relation to the first rotary axis (D), in particular in the area of run-in of the second fluid connector (15) into the valve space (5), preferably completely surrounding the area of run-in of the second fluid connector (15).

15. The multiway valve as recited in claim 1, characterized in that:
the sealing element (19) at least in areas comprises at least one elastic material, for example ethylene propylene diene monomer rubber (EPDM), comprises at least one lip seal and/or multiple-lip seal, and/or that the valve member (7) on the surface facing the insert (17) has at least one first contouring (35) and/or that the carrier (17) on the surface facing the valve member (7) has at least in areas one second contouring, and/or wherein the first contouring and/or the second contouring comprise at least one ridge, at least one edge (35) and/or at least one bead.

16. The multiway valve as recited in claim 15, characterized in that:
with the aid of the first contouring (35) and/or the second contouring, in at least a fourth position of the valve member (7), a pressure, by means of which the sealing arrangement, in particular the sealing element, is urged at least in areas in the direction of the housing, is increased, and/or that the first contouring is in contact with the second contouring (35) and/or the material reducing the friction.

17. The multiway valve as recited in claim 16, characterized in that:
the fourth position corresponds to the first position and/or the second position, in particular that, in the first position, the first sealing area (21a) is prestressed against the inner wall of the valve space (5) and/or is urged in the direction of the inner wall, and/or, in the second position, the second sealing area (21b) is prestressed against the inner wall of the valve space (5) and/or is urged in the direction of the inner wall.

18. The multiway valve as recited in claim 1, characterized in that:
the first sealing area (21a) and the second sealing area (21b) have a substantially identical surface shape and/or circumference shape and are situated in an off-set manner to each other along the circumference of the insert (17), that the second contouring comprises at least one first second contouring area overlapping at least in areas with the first sealing area (21a) and at least one second second contouring area overlapping at least in areas with the second sealing area (21b), and/or that the first sealing area (21a), in the first position, overlaps the first contouring area (35) at least in areas and/or that the second sealing area (21b), in the second position, overlaps the first contouring area (35) at least in areas, in particular is, in the first position, situated in the surface area of the carrier (17) facing away from the first sealing area (21a) and/or abuts at the surface area of the carrier (17) facing away from the first sealing area (21a) and/or, in the second position, is situated in the surface area of the carrier (17) facing away from the second sealing area (21b) and/or abuts at the surface area of the carrier (17) facing away from the second sealing area (21b), preferably, that the first sealing area (21a) as well as also the second sealing area (21b) have a surface shape, circumference shape and/or contour complementary to the first contouring (35).

19. The multiway valve as recited in claim 1, characterized by:
at least one cover (9) at least in areas closing the valve space (5) and/or at least releasably connectable to the housing (3), in particular attachable to the housing (3), wherein preferably the fixing device, in particular at least one fixing element, is at least in areas enclosed by the cover (9).

20. The multiway valve as recited in claim 19, characterized by:
at least one first, in particular fixedly specified, sealing member situated at least in areas between the housing (3) and the cover (9), in particular comprising at least one quad ring (29), wherein the first sealing member (29) at least in areas is enclosed by the housing (3) and/or the cover (9) and/or is attached to the housing and/or the cover.

21. The multiway valve as recited in claim 18, characterized in that:
the valve member (7) at least in areas is mounted in at least one second sealing member (31), which is disposed at least in areas in the cover (9), in particular is connected to the cover (9) and/or is at least in areas enclosed by the cover (9), preferably, that the second sealing member comprises at least one radial shaft seal, in particular, a radial shaft seal ring (31).
